(19) United States
(12) Patent Application Publication
(10) Pub. No.: US 2013/0202368 A1
(43) Pub. Date: Aug. 8, 2013

(54) APPARATUS FOR DISCHARGING BULK MATERIAL

(71) Applicants: Georg Ehring, Frankfurt (DE); Martin Mueller-Hasky, Frankfurt (DE); Christoph Steden, Frankfurt (DE); Frank Castillo-Welter, Frankfurt (DE); Dominic Walter, Frankfurt (DE); Horst Sachs, Oberursel (DE); Michael Stiller, Frankfurt (DE)

(72) Inventors: Georg Ehring, Frankfurt (DE); Martin Mueller-Hasky, Frankfurt (DE); Christoph Steden, Frankfurt (DE); Frank Castillo-Welter, Frankfurt (DE); Dominic Walter, Frankfurt (DE); Horst Sachs, Oberursel (DE); Michael Stiller, Frankfurt (DE)

(73) Assignees: LURGI GMBH, Frankfurt (DE); L' AIR LIQUIDE, SOCIÉTÉ ANONYME POUR L'ETUDE ET L' EXPLOITATION DES PROCÉDÉS GEORGES CLAUDE, Paris (FR)

(21) Appl. No.: 13/879,425

(22) PCT Filed: Dec. 12, 2011
(86) PCT No.: PCT/EP11/72314

§ 371 Date: Apr. 15, 2013

(30) Foreign Application Priority Data
Dec. 16, 2010 (DE) 10 2010 054 698.4

(51) Int. Cl. B65G 53/48

(52) U.S. Cl. CPC B65G 53/48
USPC 406/56

(57) ABSTRACT

An apparatus for discharging bulk material from a container containing gas includes a single-shaft screw conveyor including a conveying tube having an axis of symmetry. A purge tank is disposed downstream of the screw conveyor with the conveying tube opening into the purge tank. The purge tank includes ports for a supply and discharge of a purge gas stream and an outlet opening for the bulk material. A closing cone with a cone tip and an axis of symmetry is shiftably mounted on its axis of symmetry. The closing cone is pressed with the cone tip from outside into an outlet opening of the conveying tube. The axis of symmetry of the closing cone coincides with the axis of symmetry of the conveying tube.

### CROSS REFERENCE TO RELATED APPLICATIONS

This application is a U.S. National Phase application under 35 U.S.C. §371 of International Application No. PCT/EP2011/072314, filed on Dec. 9, 2011, and claims benefit to German Patent Application No. DE 10 2010 054 698.4, filed on Dec. 16, 2010. The International Application was published in English on Jun. 21, 2012 as WO 2012/080119 A1 under PCT Article 21 (2).

### FIELD

This invention relates to an apparatus for discharging bulk material from a container containing process gas, which is under excess pressure. In the sense of this invention, the term container is meant to include any kind of process-technological vessel, such as a reactor or an apparatus. The term excess pressure is meant to express that the container from which the bulk material is discharged is under a pressure higher than the atmospheric pressure or than the pressure of the container into which the bulk material is conveyed.

Furthermore, this invention relates to the use of such apparatus in a process for producing melamine.

### BACKGROUND

For discharging bulk material by retaining a gas flow, double flap valve systems and star feeders are widely used.

As discharging apparatus, single-shaft screw conveyors also have proven successful, whose conveying tube is closed by a weight-loaded movable flap, so that between the conveying screw and the flap the bulk material is compacted to form a plug and in this way forms a gas barrier. Such system is described in GB 1 338 114 and DE 25 07 687.

All these apparatuses have the disadvantage that their barrier effect against emerging gas is more or less imperfect. This is also true for the above-mentioned screw conveyors, as the weight-loaded flap articulated to the upper side of the opening of the conveying tube does not exert a uniform resistance to the bulk material conveyed against the same over the cross-section of the conveying tube, so that it cannot be uniformly compacted and form a granulate plug effective as gas barrier.

A conveying screw with weight-loaded closing flap is also used for example in the so-called BASF process for producing melamine. The fundamentals of this process are described in Ullmann's Encyclopedia of Industrial Chemistry, 6th Edition, Volume 21, pages 209 and 210. In this process, the melamine obtained in the gas phase, the so-called process gas, is crystallized out by mixing the process gas with a sufficiently cold gas stream and separated from the process gas by means of a cyclone separator. The melamine then present as granulate is discharged from the separator, in order to be packed and be processed further. Up to now, this process has been operated at so low pressures that the barrier effect of the discharge screw system was sufficient. In new plants, however, the trend is towards increasing the operating pressure, in order to be able to manage with lower tube conduit and container volumes. From an operating pressure of 2.5 bar in the cyclone separator, the barrier effect of the discharge screw system no longer is sufficient to keep the escape of ammonia present in particular in the process gas within reasonable limits. However, this is of particular importance due to the properties of ammonia harmful to health and the environment.

### SUMMARY

In an embodiment, the present invention provides an apparatus for discharging bulk material from a container containing gas includes a single-shaft screw conveyor including a conveying tube having an axis of symmetry. A purge tank is disposed downstream of the screw conveyor with the conveying tube opening into the purge tank. The purge tank includes ports for a supply and discharge of a purge gas stream and an outlet opening for the bulk material. A closing cone with a cone tip and a respective axis of symmetry is shiftably mounted on its axis of symmetry. The closing cone is pressed with the cone tip from outside into an outlet opening of the conveying tube. The respective axis of symmetry of the closing cone coincides with the axis of symmetry of the conveying tube.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows an exemplary design of the discharging apparatus in accordance with the invention;

FIG. 2 shows an arrangement of the exit opening of the conveying tube and of the closing cone with conically tapered end of the conveying tube in accordance with the invention; and

FIG. 3 shows the closing cone in accordance with the invention, equipped with cutting plates.

### DETAILED DESCRIPTION

An aspect of the invention is to provide an apparatus for discharging bulk material from a container supplied with process gas and under excess pressure, which apparatus is suitable to avoid the entrainment of gas, better than the known apparatuses. In addition, an aspect of the invention is to provide a process for producing melamine, which can be operated with increased pressure, by avoiding an increased escape of ammonia into the environment when discharging the melamine granulate.

In an embodiment, the present invention provides an apparatus including a single-shaft screw conveyor and a downstream purge tank, wherein the conveying tube of the screw conveyor opens into the purge tank. A plug shiftably mounted on an axis of symmetry, which has the shape of a cone, subsequently referred to as closing cone, is pressed by a spiral spring with the tip of the cone first, against the flow direction of the bulk material, from the outside into the outlet opening of the conveying tube. The conveying tube of the screw conveyor, the closing cone and the spiral spring are arranged relative to each other such that their axes of symmetry coincide. The purge tank is equipped with ports for the supply and discharge of a purge gas stream and with an outlet opening for the bulk material.

In operation, the bulk material is pressed through the conveying tube against the closing cone by the conveying screw of the screw conveyor. The closing cone moves back and clears a part of the cross-section of the outlet opening of the conveying tube for the exit of the bulk material. In the process, the spiral spring is tensioned and builds up a force against the flow direction of the bulk material, which is transmitted from the closing cone to the bulk material. As a result, the bulk material is com-pressed in the conveying tube, where it forms a barrier against the inflowing gas from the discharge tank.

The advantage of the closing cone lying on the line of symmetry of the conveying tube as compared to the flap known from GB 1 3 38 114 is that it forms a uniform flow resistance for the bulk material flowing through the conveying tube over the entire cross-section. In this way, a higher compaction of the bulk material can be effected, and hence a higher barrier effect of the bulk material plug against inflowing gas can be achieved. The conical shape prevents the closing cone from laterally breaking out from the axis of symmetry of the conveying tube and supports the central position of the closing cone in the conveying tube. This effect is achieved best when the angle formed by the cone radius and the cone generatrix is equal to or greater than the angle of repose of the bulk material.

The bulk material drops from the opening of the conveying tube into the purge tank, which is provided directly downstream of the screw conveyor. In the lower region of the purge tank, one or more ports are installed for the inlet of purge gas into the container. These ports can be designed as nozzles. The container can have a round, square or rectangular cross- section. The bottom of the container can be formed as cone, as is usual for bulk materials. The inlets for the purge gas should be installed in the container as low as possible, so that the bulk material is purged by gas. When purging of the bulk material should be effected particularly thoroughly, the container bottom and the addition of the purge gas can be designed such that a fluidized bed is formed.

Alternatively, the purge gas inlets can also be installed above the bulk material filling, when purging of the bulk material can be omitted. In the bottom region of the container, means for loosening the bulk material, for comminuting bulk material lumps, or for eliminating bridge formations can be installed.

The outlet of the bulk material from the purge tank is effected via a gas-tight discharge system, such as a star feeder.

On the upper surface of the purge tank the outlet for the purge gas laden with the process gas is located, from which it can be supplied to a gas cleaning The chemical composition of the purge gas depends on the type of bulk material. In many applications, nitrogen or dry air are employed as purge gas.

To achieve the desired barrier effect against inflowing process gas by compaction of the bulk material in the conveying tube of the conveying screw and at the same time avoid clogging of the screw conveyor, not only the size of the opening angle of the closing cone, but also the shape of the exit of the conveying tube can be adapted to the properties of the bulk material.

In an advantageous design of the apparatus, the conveying tube is conically tapered towards the exit. In this way, an additional pressing force acting in radial direction is produced on the bulk material plug, and thus its density and barrier effect are increased. To avoid clogging of the exit, the taper angle should be kept smaller than the angle of repose, so that the bulk material can slip down on the inside of the exit cone.

In a further advantageous aspect of the invention a conical enlargement of the conveying tube towards the exit is provided. This variant is particularly advantageous for bulk material with a great tendency to form lumps, because in this variant the cross-sectional area between conveying tube wall and closing cone constantly increases towards the exit.

In a further advantageous aspect of the invention it is provided to let a conical enlargement follow a conical taper of the conveying tube. This variant is used when radial pressing forces initially are desired, in order to produce a dense bulk material plug, but when the bulk material tends to form lumps, an expanding exit cross-section is required for discharging from the conveying tube.

In a further advantageous aspect of the invention the discharge of the bulk material from the conveying tube is improved, in that cutting plates in the form of a logarithmic spiral are mounted on the closing cone. By means of a relative rotary movement between the bulk material compacted to a plug and the dosing cone, the cutting plates cut the bulk material out from the plug. This variant is being used when the bulk material has an extreme tendency to form lumps. The cutting plates extend from the cone center to the outside, but only so far that the closing function is not impeded.

The apparatus according to the invention is particularly suitable for use in processes known per se for producing melamine. In these processes, melamine which initially is present in gaseous form, in a gas mixture, the so-called process gas, with chiefly gaseous ammonia and carbon dioxide, is crystallized out from the gas phase by cooling and is then separated from the process gas in the form of a granulate by means of a cyclone separator. When discharging the granulate from the separator, there is the problem to prevent an outflow of process gas, since it is harmful to health because of its ammonia content. By using the apparatus according to the invention it is possible to limit the amount of process gas escaping into the environment.

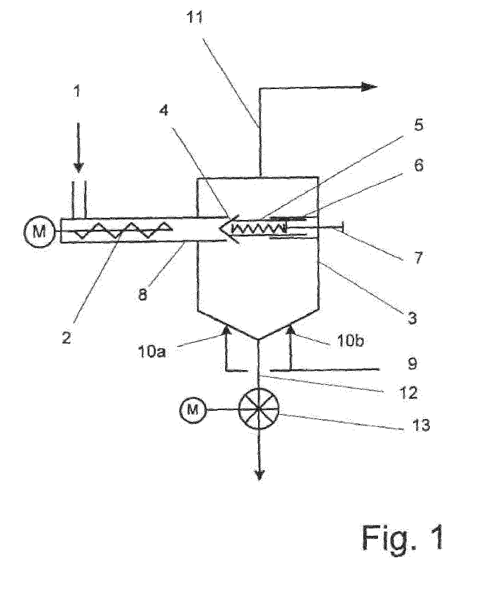

With reference to FIG. 1 the fundamental construction and the mode of function of the discharging apparatus according to the invention will be explained. The bulk material (1) laden with a process gas is supplied from a non-illustrated container, which is under excess pressure, to the screw conveyor (2). Directly downstream of the screw conveyor (2) the purge tank (3) is provided. By the coil spring (5), the closing cone (4) is pressed into the opening of the screw conveyor (2) towards the bulk material and held in position by a fixture (6). By means of a spindle means (7), the tension of the coil spring (5) is adjusted. The bulk material is compacted in the conveying tube (8) of the screw conveyor (2) and thus forms a barrier against inflowing process gas. The purge tank (3) is supplied with a purge gas stream (9). The ports (10a, b) of the purge gas are installed on the bottom surface of the purge tank (3) such that the bulk material is traversed by the purge gas. The purge gas laden with the process gas leaves the purge tank via conduit (11) and is supplied to a non-illustrated gas cleaning The bulk material is discharged from the purge tank via conduit (12) and the star feeder (13) and supplied to the further treatment.

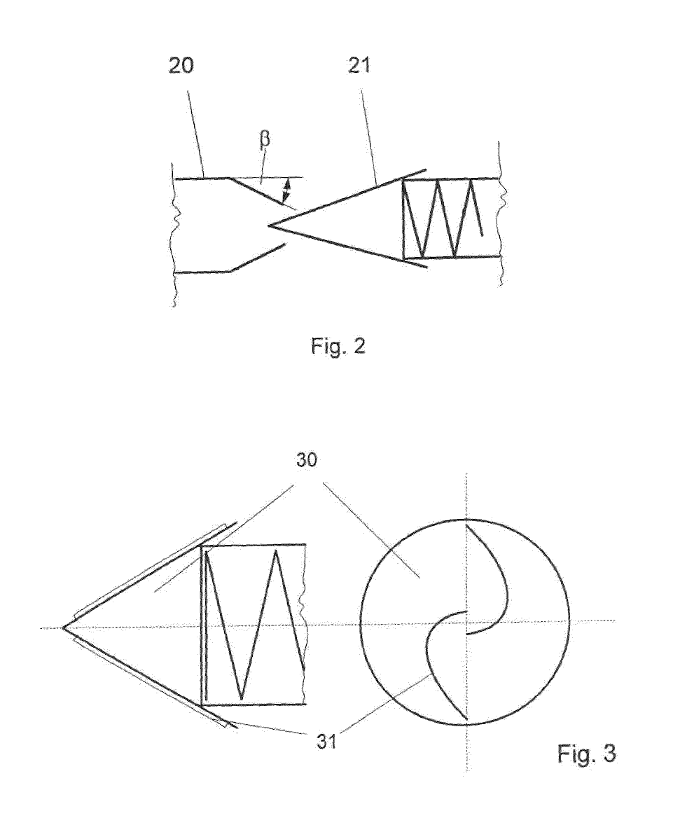

FIG. 2 schematically shows the exit opening of a conveying tube (20), in this case conically tapered, with the taper angle and the closing cone (21).

FIG. 3 schematically shows a longitudinal section and a front view of a closing cone (30) on which cutting plates (31) in the form of a logarithmic spiral are mounted.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

### LIST OF REFERENCE NUMERALS

(1) bulk material
(2) screw conveyor
(3) purge tank
(4) closing cone
(5) coil spring
(6) fixture
(7) spindle means
(8) conveying tube
(9) purge gas stream
(10) ports for purge gas stream
(11) conduit for discharging the laden purge gas stream
(12) conduit for discharging the bulk material
(13) star feeder
(20) conveying tube
(21) closing cone
(30) closing cone with cutting plates
(31) cutting plates

1-7. (canceled)

8: An apparatus for discharging bulk material from a container containing gas. the apparatus comprising:
a single-shaft screw conveyor including a conveying tube having an axis of symmetry;
a purge tank disposed downstream of the screw conveyor with the conveying tube opening into the purge tank, the purge tank including ports for a supply and discharge of a purge gas stream and an outlet opening for the bulk material; and
a closing cone having a cone tip and a respective axis of symmetry, the closing cone being shiftably mounted on its axis of symmetry and being pressed with the cone tip from outside into an outlet opening of the conveying tube, wherein the axis of symmetry of the closing cone coincides with the axis of symmetry of the conveying tube.

9: The apparatus according to claim 8, wherein an end of the conveying tube is conically tapered.

10: The apparatus according to claim 8, wherein an end of the conveying tube is conically enlarged.

11: The apparatus according to claim 8, wherein a conical enlargement follows a conical taper of the conveying tube.

12: The apparatus according to claim 8, wherein cutting plates in the form of a logarithmic spiral are mounted on the closing cone.

13: The apparatus according to claim 8, wherein an angle formed by cone radius and cone generatrix is equal to or greater than an angle of repose of the bulk material.

14: A method of producing melamine, the method comprising:
conveying a bulk material to a purge tank using a single-shaft screw conveyor including a conveying tube having an axis of symmetry;
providing a closing cone having a cone tip and a respective axis of symmetry, the closing cone being shiftably mounted on its respective axis of symmetry;
pressing the closing cone with the cone tip from outside into an outlet opening of the conveying tube, wherein the axis of symmetry of the closing cone coincides with the axis of symmetry of the conveying tube;
supplying and discharging a purge gas stream to the purge tank through ports in the purge tank; and
discharging the bulk material through an outlet opening in the purge tank.
